(19) United States
(12) Patent Application Publication
(10) Pub. No.: US 2010/0218142 A1
(43) Pub. Date: Aug. 26, 2010

(54) Associating a Message with an Item

(75) Inventors: Tina Chen, San Francisco, CA (US); Nundu Janakiram, Sunnyvale, CA (US); Pierre Delisle, San Jose, CA (US); Joseph M. Ashear, Palo Alto, CA (US); Graham Jenkin, San Francisco, CA (US); Ariel H. Bardin, Belmont, CA (US); Ye-Jeong Kim, Menlo Park, CA (US)

Correspondence Address: FISH & RICHARDSON P.C., PO BOX 1022, MINNEAPOLIS, MN, 55440-1022, US

(73) Assignee: Google Inc.

(21) Appl. No.: 12/392,617

(22) Filed: Feb. 25, 2009

(51) Int. Cl. G06F 3/048; G06F 17/30

(52) U.S. Cl. 715/854; 715/764; 707/E17.009; 707/E17.045

(57) ABSTRACT

Associating a message with an item includes detecting a characteristic of a first item located at a first node level of a hierarchy of items. The method includes associating a first message with the first item based on the characteristic, the first message preconfigured for presentation to a user regarding the characteristic. The method includes registering the first message, based on the association with the first item, to be presented at a second node level in the hierarchy in a user interface, the first node level descending from the second node level in the hierarchy.

### TECHNICAL FIELD

This document relates to information processing.

### BACKGROUND

Some computer systems are configured to track a status of objects. For example, various characteristics relating to an object can be considered desirable or undesirable and a corresponding status can therefore be tracked. Some systems can generate a message indicating the status of the object(s).

Some computer systems organize objects in different levels. For example, high and low hierarchy levels can be used for aspects having higher or lower granularity, respectively. Some systems allow users to navigate between two or more such levels to view different information.

### SUMMARY

In a first aspect, associating a message with an item includes detecting a characteristic of a first item located at a first node level of a hierarchy of items. The method includes associating a first message with the first item based on the characteristic, the first message preconfigured for presentation to a user regarding the characteristic. The method includes registering the first message, based on the association with the first item, to be presented at a second node level in the hierarchy in a user interface, the first node level descending from the second node level in the hierarchy. The first aspect can be implemented as a computer-implemented method or a computer program product, for example.

Implementations can include any, all or none of the following features. A definition for the first message can specify at least the first node and the characteristic, and the first message can be associated with the first item based on matching the first node and the characteristic with the definition. The definition can further include hierarchy information identifying at least one of a node level directly above the first node level in the hierarchy and a node level directly below the first node level in the hierarchy. The method can further include presenting the first message at the first node level of the hierarchy in the user interface, the first message indicating to the user that the first item has the characteristic. The method can further include receiving a first user input indicating a navigation from the first node level to the second node level; generating a message aggregation, including aggregating the first message with any other message having been registered for presentation at the second level; presenting the message aggregation at the second node level of the hierarchy in the user interface, the message aggregation including at least the first message and relating to a plurality of items including the first item, displayed at the second node level of the hierarchy. The message aggregation can be generated based on a type of the first message, and the message aggregation can include the first message and any other message of the type that has been registered for presentation at the second level. The method can further include receiving a second user input indicating a navigation from the second node level to the first node level; and in response to the second user input, presenting the first node level in the user interface including at least the first item, the first message, and any other message relating to at least one of the first node level and any lower node level descending from the first node level. The method can further include receiving a second user input indicating a selection of a select message in the message aggregation; in response to the second user input, generating a filtered group, including filtering the plurality of items to retain any messages relating to the select message; and presenting the filtered group in the user interface, the filtered group associated with the select message. Filtering the plurality of items can include bringing together in the filtered group items that descend through multiple node levels from a common node in the hierarchy. The method can further include receiving a second user input indicating a dismissal of the first message at the second node level; and in response to the second user input, ceasing to present the first message at the second node level. After the dismissal the first message can continue to be associated with the first item and be subject to presentation upon the first node level being presented. Detecting the characteristic can include applying a rule to information of the first item, the first message associated with the rule such that upon the rule being satisfied, the first message is associated with the information. The user interface can be configured for use by an advertiser in managing advertisement campaigns, the first item can include a campaign component indicating that the advertiser has bid on a keyword for presenting an advertisement, and the first node level can be a keyword level of the hierarchy. The characteristic can include that a current status of the campaign component is that the advertisement is not being presented in response to the keyword occurring. The characteristic can include that the campaign component is currently inactive. The characteristic can include that the campaign component is scheduled to end within a predetermined amount of time.

In a second aspect, a graphical user interface for associating a message with an item includes a node information area presenting information about any of multiple node levels in a hierarchy, the node information area including information about a first item at a first node level that is associated with a first message, the first message registered to be presented at a second node level in the hierarchy. The graphical user interface includes a message aggregation area associated with the second node level of the hierarchy, the first node level descending from the second node level, the message aggregation area including a message aggregation comprising at least the first message and any other message relating to the hierarchy that is registered for presentation at the second level. The graphical user interface can be implemented using a computer program product tangibly embodied in a computer-readable storage medium.

Implementations can include any, all or none of the following features. The graphical user interface can be configured for use by an advertiser in managing advertisement campaigns, the first item can include a campaign component indicating that the advertiser has bid on a keyword for presenting an advertisement, and the first node level can be a keyword level of the hierarchy. The characteristic can include at least one selected from: a current status of the campaign component is that the advertisement is not being presented in response to the keyword occurring; the campaign component is currently inactive; and the campaign component is scheduled to end within a predetermined amount of time.

Implementations can provide any, all or none of the following advantages. Improved message presentation can be provided. A system can be provided that aggregates messages from one or more lower node levels for presentation at a higher node level. One or more node levels intermediate the level of the message and the higher level at which the messages are being aggregated can be substantially bypassed or ignored in the aggregation. A message can be dismissed at the higher aggregation level and remain associated with the affected item at the lower level.

The details of one or more embodiments are set forth in the accompanying drawings and the description below. Other features and advantages will be apparent from the description and drawings, and from the claims.

### DESCRIPTION OF DRAWINGS

FIGS. 1A-D show example graphical user interfaces that can present one or more messages.

FIG. 2 shows an example of a method that involves a message associated with an item.

FIG. 3 shows an example system that can be used for associating a message with an item.

FIG. 4 is a block diagram of a computing system that can be used in connection with computer-implemented methods described in this document.

Like reference symbols in the various drawings indicate like elements.

### DETAILED DESCRIPTION

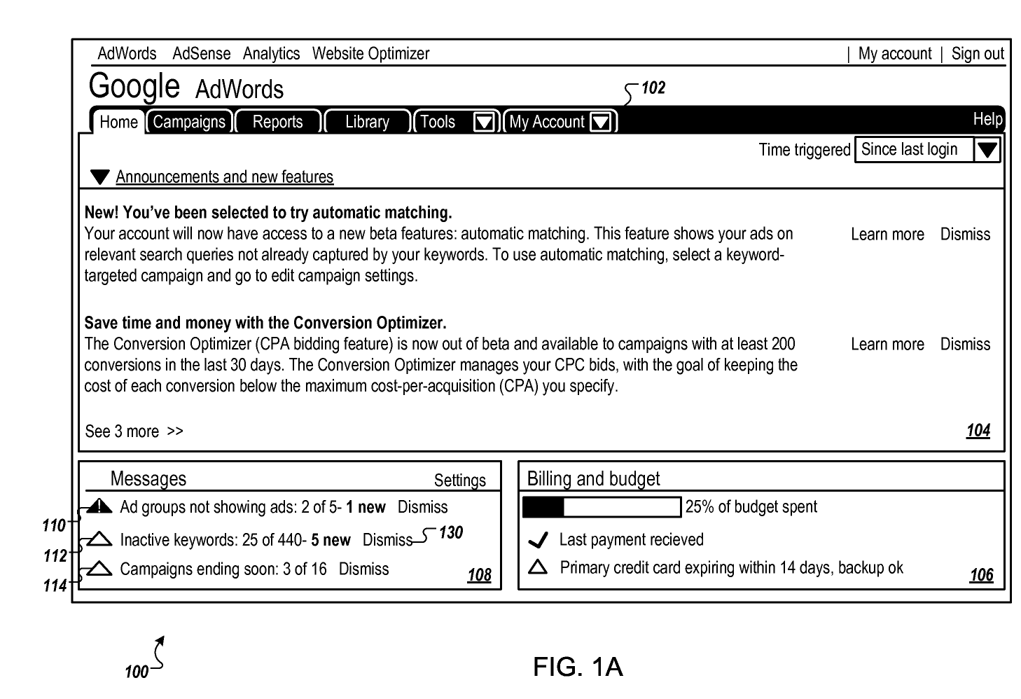

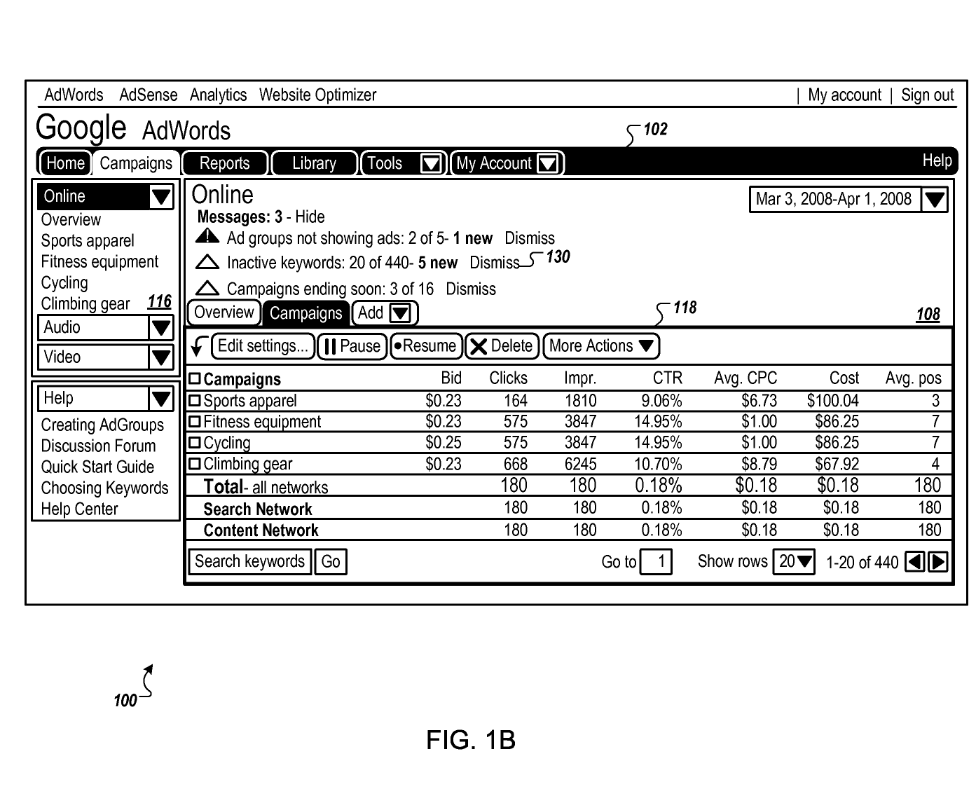

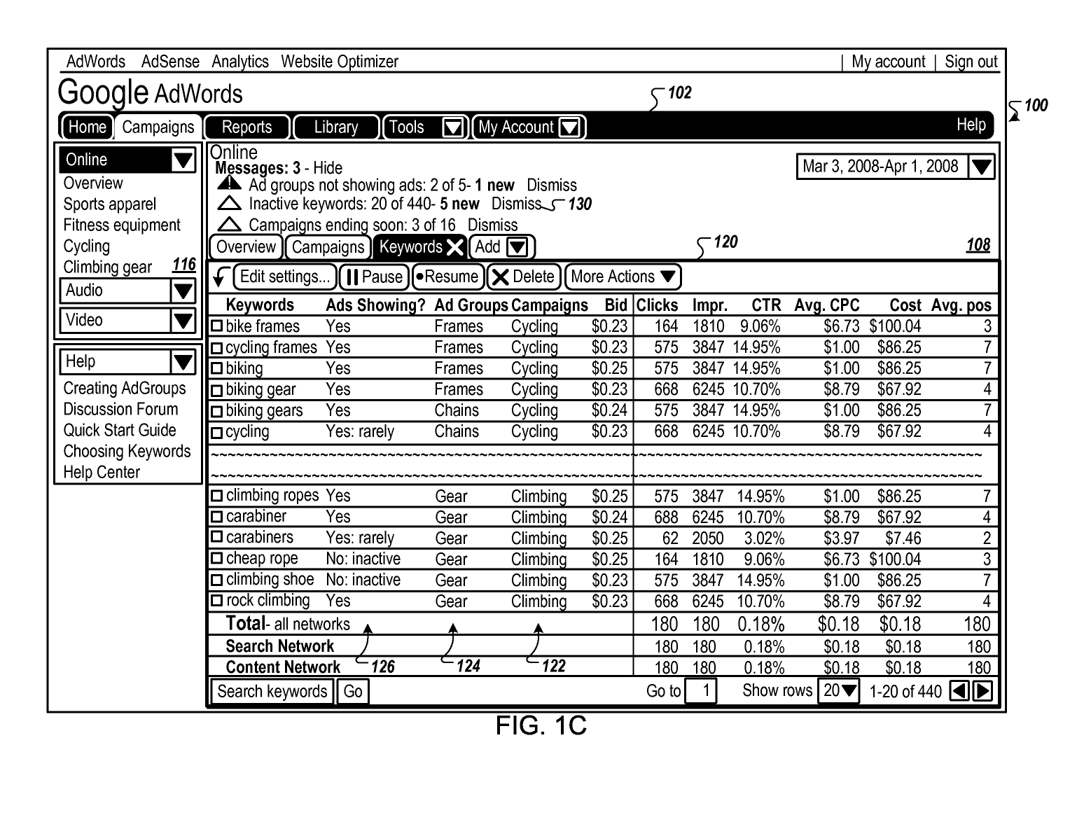

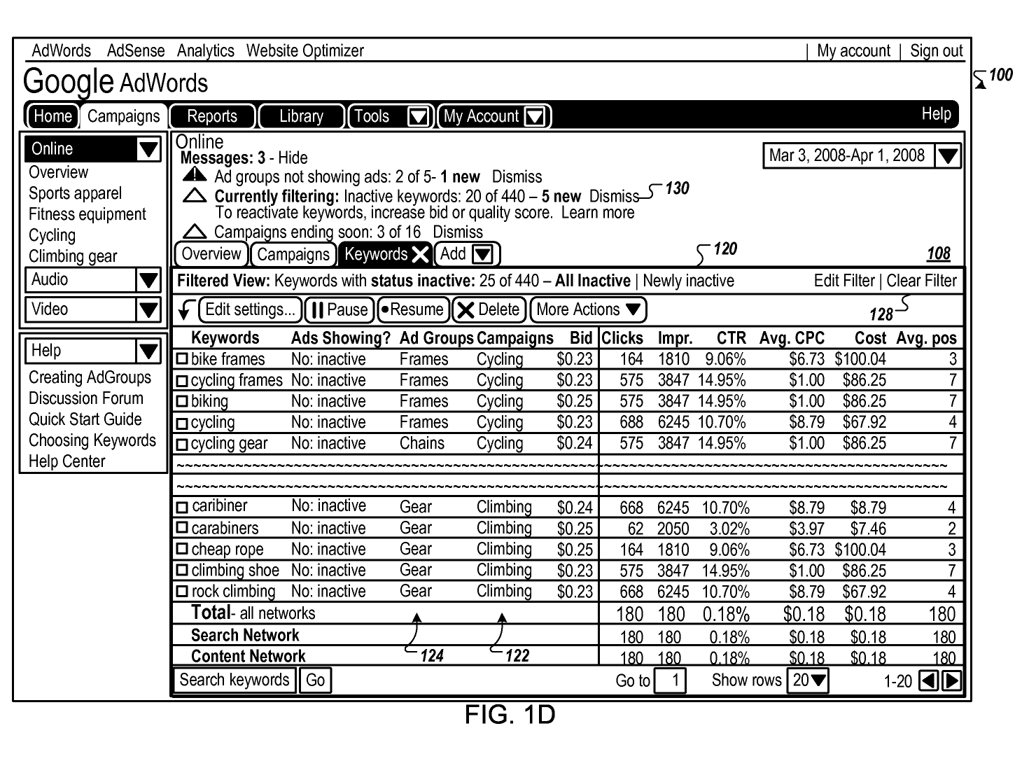

FIG. 51A-D show example graphical user interfaces that can present one or more messages. In FIG. 1A, a graphical user interface (GUI) 100 is generated on any type of device, such as a personal computer, handheld device, cellular telephone or a server device, to name a few examples. In some implementations, the GUI 100 relates to content distribution in an online network and can include one or more messages about such distribution. For example, the GUI 100 can be generated to a content provider such as an advertising entity to aid that entity in managing, evaluating and/or otherwise interacting with one or more advertisement campaigns.

Here, the GUI 100 includes a toolbar 102 that can include user-selectable controls such as Home, Campaigns, Reports, Library, Tools and My Account. Any or all of the controls in the toolbar 102 can cause another screen to be presented in the GUI 100. In some implementations, a content provider can use the toolbar 102 to navigate among structured information relating to multiple campaigns, such as to review one or more keyword that the content provider has chosen to be associated with a particular campaign. In the current example, the Home control is selected in the toolbar 102.

The GUI 100 can include an announcements area 104 that includes one or more portions of information intended for the user, such as account information directed to a content provider participating in a content distribution system, for example an advertising collaboration between one or more advertisers and publishers. For example, a content distributor may manage and generate the GUI 100 to aid content providers involved in the collaboration. The GUI 100 can include a financial area 106 that can contain and/or illustrate one or more financial aspects of the content distributor's campaign, such as billing and/or budget.

The GUI 100 here includes a message area 108 that is configured to present any or all currently applicable messages relating to some aspect of the campaign. In some implementations, a message can be associated with one or more items based on the item(s) having a particular characteristic. The message contents presented in the message area 108 can reflect such characteristic(s) in some implementations. For example, the message area 108 can include a “not-showing-ads” message 110, an “inactive keywords” message 112 and/or a “campaigns ending soon” message 114.

The message area can include one or more messages because a registration of it/them indicates they are to be presented. In some implementations, messages can be aggregated for display in the screen associated with the Home control in the toolbar 102. For example, the Home screen can be considered a level that is relatively high in a hierarchy of items (e.g., items can form one or more components of campaigns subsumed under the Home screen). More detailed screens in the hierarchy, by contrast, can be considered levels that are relatively low in the hierarchy.

Here, a user of the GUI 100 can select any of multiple controls in the GUI 100 to navigate to another screen. For example, assume that the user chooses the Campaigns control in the toolbar 102.

FIG. 1B shows an example of the GUI 100 that can be presented after the user chooses the Campaigns control in the toolbar 102. The GUI 100 can include the message area 108, for example in another location and/or with a different appearance than shown at the Home screen. In this example, the message area 108 includes the aggregated messages that were mentioned above.

The GUI 100 can include one or more other features after such navigation. In some implementations, the GUI 100 can include a hierarchy area 116. For example, the hierarchy area 116 can be used to navigate to one or more levels of a hierarchy, such as to an Online level, a Fitness equipment level or to a Climbing gear level. The levels in the hierarchy area 116 in this example are campaigns defined for a content distributor such as an advertiser.

The GUI 100 can include a campaign area 118. In some implementations, the campaign area 118 can identify one or more campaigns that the user has defined, such as content distribution campaigns. Here, the campaign area 118 includes four campaigns directed to Sports apparel, Fitness equipment, Cycling and Climbing gear, respectively. In some implementations, the campaigns can be considered to be nodes at a level of a hierarchy recognized in the system generating the GUI 100. For example, any or all of the campaigns can be associated with one or more keywords, and such keyword(s) can be considered to form another level of the hierarchy, such as a level lower than that of the campaign(s). As an example, the aggregated messages in the message area 108 can be presented also at the current node level.

In some implementations, a user can navigate to one or more other node levels in the GUI 100. For example, a user can navigate from the screen showing the campaign area 118 to a screen presenting one or more keywords associated with a campaign. In some implementations, a user can select an “Add” tab and add one or more tabs, such as “Keywords” or “Ads” tabs. FIG. 1C shows an example where the GUI 100 includes a keyword area 120. For example, a “Keywords” tab that is currently selected may have been added using the “Add” tab. The keyword area 120 can inform the user about which keyword(s) a particular campaign includes, and can provide related information regarding the keyword(s), such as one or more messages associated with an item or items in the area 120.

Here, for example, the keyword area 120 includes items presented in a list. In other implementations, any other form of presenting content in the area 120 can be used, such as graphs and/or icons. The list can include a campaign column 122 that can identify, for each keyword, a campaign that is associated with the keyword. Here, for example, campaigns for Cycling, Fitness and Climbing are shown. The bottom of the keyword area 120 indicates that the GUI 100 presently shows only some of a larger number of keywords registered in the system, and the GUI 100 can provide for user navigation to view other keywords and/or items associated with them that are not presently visible.

The keyword area 120 can include a group column 124 indicating an association group to which one or more of the items and/or keywords belong. In some implementations, the group column 124 indicates advertisement groups (e.g., Ad Groups) with which the keywords are associated. Other content distribution groups can be indicated by the group column 124. Here, for example, the group column 124 indicates that respective keywords are associated with Ad Groups for Frames, Chains, Tires, Weights and Gear. Other Ad Groups can be used.

The GUI 100 can include the toolbar 102, the message area 108 and/or the navigation area 116 while the keyword area 120 is being displayed. Other areas can occur.

The GUI 100 can include a status column 126. In some implementations, the status column 126 can indicate a status that the system associates with each keyword and/or an item thereof. For example, the status column here is entitled “Ads Showing?” and relates to a status whether a content distribution function is currently set to distribute content (e.g., an advertisement) in response to occurrence of a particular keyword. The status column 126 indicates that for some keywords in this example the content distribution function is currently set to distribution (e.g., the status is “Yes”) and for other keywords the content distribution function is currently not set to distribution (e.g., the status is “No: disapproved”).

Any characteristic regarding an item, for example its status, can be determined. In some implementations, a system can apply a rule to one or more information portions (such as to all or part of the information associated with a keyword). For example, the rule can determine whether for a particular keyword the content distribution function is currently set to distribute content upon occurrence of the keyword, and generate a suitable output (e.g., a yes or no result). Thus, in some implementations, a characteristic of an item located at a node level of a hierarchy of items can be detected.

A message can be associated with an item to reflect some aspect thereof. In some implementations, the message can be attached based on whether the rule is satisfied. For example, a message corresponding to the “Ad groups not showing ads” indicator in the message area 108 can be associated with any keyword and/or item in the keyword area 120 that currently has a status consistent therewith. Thus, in some implementations, a message can be associated with the item based on the characteristic. For example, the message can be preconfigured for presentation to a user regarding the characteristic.

Messages can relate to any of multiple characteristics. In some implementations, the characteristic can concern a status such as whether the item (e.g., a campaign component such as a keyword) is currently active. For example, some of the keywords shown in the keyword area 120 in the current example are presently labeled as inactive, and the message area 108 can include an “Inactive keywords” indicator that reflects how many of the keywords (e.g., determined by aggregating the respective messages) are currently inactive. As another example, the characteristic can relate to the scheduling of a particular campaign, such as whether the campaign will end soon (e.g., within a predetermined amount of time). The message area 108 can include a “Campaigns ending soon” indicator that reflects how many of the keywords (e.g., determined by aggregating the respective messages) are associated with respective campaigns scheduled to end in the near future. Other characteristics can be used.

In some implementations, upon the user navigating from a screen that reflects a relatively higher level in the node hierarchy (e.g., the screen in FIGS. 1A and/or 1B) to a screen that reflects a relatively lower level in the hierarchy (e.g., the screen in FIG. 1C), the screen can retain those of the messages that relate to nodes at the lower level and to nodes below the level of the screen. For example, in the present illustration, each of the “Ad groups not showing ads” indicator, the “Inactive keywords” indicator, and the “Campaigns ending soon” indicator are visible in the message area 108 and have the same numerical information (e.g., “2 of 5” for the Ad groups not showing ads indicator). In some implementations, the messages are associated with respective node levels by registering the message with the corresponding node level(s), for example such that the GUI 100 can aggregate messages at the appropriate level. In other implementations, messages can be retained and/or omitted in other ways in navigation, such as to retain messages pertaining to more or all node levels.

In some implementations, a user can navigate upward in the node hierarchy from a relatively lower level (such as from the GUI 100 as presented in the FIG. 1C example) to a relatively higher level (such as FIG. 1A or 1B). The higher node level can include those messages relating to the lower-level node and its descendant nodes, and any other messages registered as pertaining to the higher node level that may not have been presented at the lower node level. For example, an aggregation of messages at the higher node level can include adding a message type to the message area 108 that was not included at the lower node level. As another example, an aggregation can include modifying a numerical indicator of a message type that was represented at the lower level, the numerical indicator modified to reflect one or more additional messages pertaining to that message type at the higher node level. Other approaches for aggregation can be used.

In some implementations, a user presented with information at a particular node level in the hierarchy can cause the GUI 100 to display fewer items relating to one or more specific messages. In some implementations, such operation can be caused by the user clicking or otherwise selecting a message indicator, such as in the message area 108. For example, a user can click on the “Inactive keywords” indicator to cause the GUI 100 to present items associated with the “Inactive keywords” message. The selection of the indicator in the message area 108 can be performed in one or more situations, such as in any or all of the exemplary screens presented in FIGS. 1A-C.

In response to the “Inactive keywords” indicator being selected, the GUI 100 can be presented as illustrated in FIG. 1D. The keyword area 120 now includes those items associated with the inactive status. In some implementations, the item(s) to be presented can be identified by performing a filtering on a larger number of items, such as those presented in FIG. 1C. For example, the larger number of items can be filtered to exclude any that are not associated with the relevant status (e.g., any not currently inactive) and to include any that currently have the relevant status. In the example, the items resulting from the filtering are associated with the status that the keyword is currently inactive.

In some implementations, the item(s) presented as a result of filtering can relate to one or more higher nodes in the hierarchy. For example, the currently “inactive” keywords presented in the FIG. 1D example each relates to one of multiple campaigns according to the column 122. As another example, each of the items relates to one of multiple groups according to the group column 124. Accordingly, the present example illustrates that items associated with a common message (e.g., relating to the status of being inactive) can be grouped for presentation in a common area, substantially without dividing or otherwise separating the items due to them being descendants of respective different higher node levels. As another example, the aggregation can be performed substantially or essentially without regard to any intervening node level(s) in the hierarchy 350.

In some implementations, clicking on or otherwise selecting a message can also trigger navigation to another view of the corresponding node. For example, the user may have been viewing a campaign table, and clicked on a message about keywords. This can cause a table of keywords to be presented. In some implementations, instead of filtering, all of the items associated with one or more messages can be pulled into a special view where the user can see all the objects associated with the message(s).

The user can return to viewing a collection of a larger number of items. In some implementations, a clear filter control 128 can be used. For example, selecting the clear filter control 128 can cause items to be gathered for presentation in the keyword area 120 without restriction to the current status, such as to again present substantially the contents that the keyword area 120 has in FIG. 1C.

Any or all of the indicators in the message area 108 can be associated with a dismiss control 130. Upon selection by a user, the dismiss control 130 can cause the indicator (e.g., the “Inactive keywords” indicator) to be removed from the message area 108. In some implementations, the message can remain associated with the individual item(s) also after the control 130 is selected. For example, clicking on the dismiss control 130 for the “Inactive keywords” indicator in either or all of FIGS. 1A-D can cause the message area 108 to appear with only the “Ad groups not showing ads” and “Campaigns ending soon” indicators visible. For example, the items (e.g., individual keywords) currently having inactive status can remain associated with the corresponding message regarding this characteristic, such as for presentation of that message at a lower level in the node hierarchy. Thus, the dismiss control 130 can cause message-related information to be removed from an aggregation area (such as the message area 108) while the message(s) remain associated with their respective item(s).

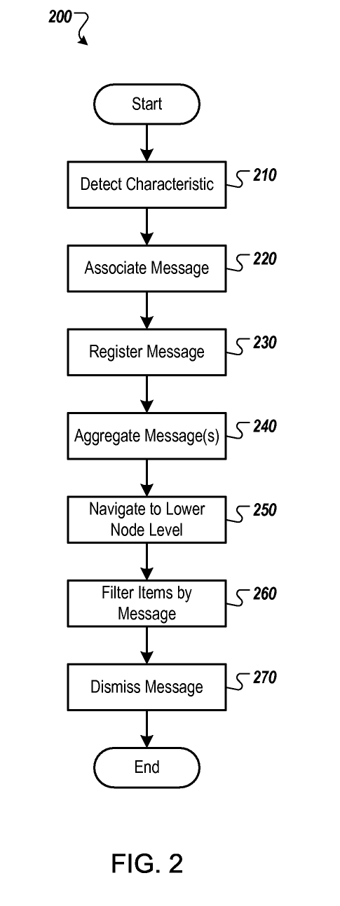

FIG. 2 shows an example of a method 200 that involves a message associated with an item. In some implementations, the method 200 can be implemented to be executed by a processor executing instructions stored in a computer-readable storage medium. For example, performing the method 200 can cause the GUI 100 to be presented as illustrated in any or all of FIG. 1-D.

In step 210, a characteristic of an item is detected. The item can be located at a first node level of a hierarchy of items. For example, any or all statuses of keywords can be detected, such as the characteristic of having “inactive” status.

In step 220, a message is associated with the item based on the characteristic. The message can be preconfigured for presentation to a user regarding the characteristic. For example, a message regarding a keyword having inactive status can be associated with currently inactive keyword(s).

In step 230, the message is registered, based on the association with the item, to be presented at another node level in the hierarchy in a user interface. The first node level can descend from the second node level in the hierarchy. For example, messages regarding respective keywords having inactive status can be registered to facilitate aggregated presentation in the message area 108.

In step 240, messages can be aggregated. In some implementations, the “Inactive keywords” messages can be aggregated and the numerical indicator “20 of 440” can be presented in the message area 108. For example, aggregating the messages can include determining that 20 of 440 keywords are currently inactive.

In step 250, a user can navigate to a lower level in the node hierarchy. For example, the user can view the GUI 100 as illustrated in the FIGS. 1A and 1B examples, and from either of them can navigate to the GUI 100 as illustrated in the FIG. 1C example. On such navigation, message(s) related to the present node level and to descendant nodes can be retained and one or more other messages can be omitted. In step 260, one or more items can be filtered by message. For example, a user can click any of the indicators in the message area 108 to cause the GUI 100 to present only the item(s) having the corresponding message. Generating the resulting view can include filtering the items.

In step 270, one or more messages can be dismissed. In some implementations, a user can select any of the dismiss controls 130 to cause one or more messages to be dismissed from the message area 108. For example, dismissal can cause the corresponding indicator to be removed from the message area 108 without removing the association between the message and the underlying item(s).

In some implementations, more or fewer steps can be performed. As another example, one or more steps can be performed in another order.

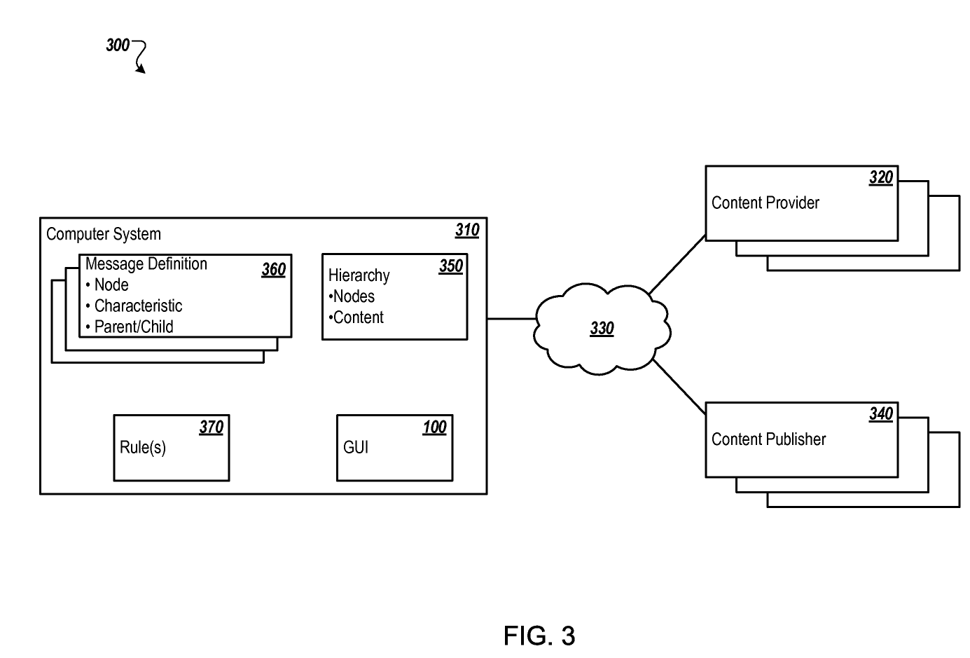

FIG. 3 shows an example system 300 that can be used for associating a message with an item. Here, the system 300 includes a computer system 310 such as a personal computer, a handheld device or a server computer, to name a few examples. In some implementations, the computer system 310 can be controlled and used by a content distributor, such as an entity that distributes content (e.g., advertisements) on behalf of one or more other entities.

The system 300 can include one or more content provider systems 320 connected to the computer system 310 through any kind of network 330, such as a private network or the Internet. In some implementations, an entity using the content provider system(s) 320 can make one or more content portions available for distribution by a content distributor. For example, the content provider can have an agreement with the content distributor for distribution of contents, such as one or more advertisements, on behalf of the content provider. The content provider system 320 can include any type of system, such as a server computer.

The system 300 can include one or more content publisher systems 340 connected to the computer system 310 through the network 330. In some implementations, an entity using the content publisher system(s) 340 can publish content, such as a network page, that includes one or more content portions provided by the content provider system(s) 320. For example, the content publisher can generate and make publicly available an Internet page that is configured to be augmented by one or more content portions, such as advertisements, on behalf of the content provider. The content publisher system 340 can include any type of system, such as a server computer.

The computer system 310 can use a hierarchy 350 in one or more aspects of its operation. In some implementations, the hierarchy 350 can include node levels reflecting multiple degrees of granularity of content or other information processed by the computer system 310, such as campaigns and/or keywords.

The computer system 310 can include one or more message definitions 360. In some implementations, any or all of the message definitions 360 can relate to a characteristic of an item managed by the computer system 310. For example, one of the message definitions 360 can relate to the status that a particular group is not currently showing ads; to the status that a keyword is inactive; and/or to the status that a campaign ends within a predetermined time period. Accordingly, each of the message definitions 360 can include information about a characteristic to which it relates. Any characteristic can be involved, such as beneficial status or a detrimental situation that causes one or more alerts. The message definition 360 can be used in associating an applicable message with one or more items.

Each of the message definitions 360 can include information about the node to which it relates. For example, if the message relates to keywords the message definition 360 can identify the corresponding node level of the hierarchy 350 to indicate that the message applies at that level.

Each of the message definitions 360 can include information about a parent and/or child node of the node level to which the message relates. For example, the definition for a message that applies at a keyword node level can have information that the keyword node level descends directly from a higher node level, such as a campaigns node level. As another example, the message definition 360 can identify a child node level that descends from the keyword node level. In some implementations, therefore, the messages definition 360 can be said to be aware of the hierarchy 350.

The computer system 310 can include one or more rules 370 that can be used in detecting a characteristic of one or more items. In some implementations, the rule(s) 370 can be used to identify one or more groups currently not showing ads; to identify one or more keywords currently inactive; and/or to identify one or more campaigns ending soon. For example, upon the rule(s) being satisfied, a corresponding message can be associated with the item(s). The rule(s) 370 can be implemented as one or more logic statements or conditions, such as by formulating the rule in any programming language.

The computer system 310 can include the GUI 100. In some implementations, the computer system 310 can generate the GUI 100 in any or all of the exemplary appearances shown in FIGS. 1A-D. For example, a content provider using the content provider system 320 can access the GUI 100 in the computer system 310 to investigate and/or control the content distribution.

In some implementations, one or more components of the computer system 310 can be located in another physical system than other components. As another example, additional components can be used in the computer system 310.

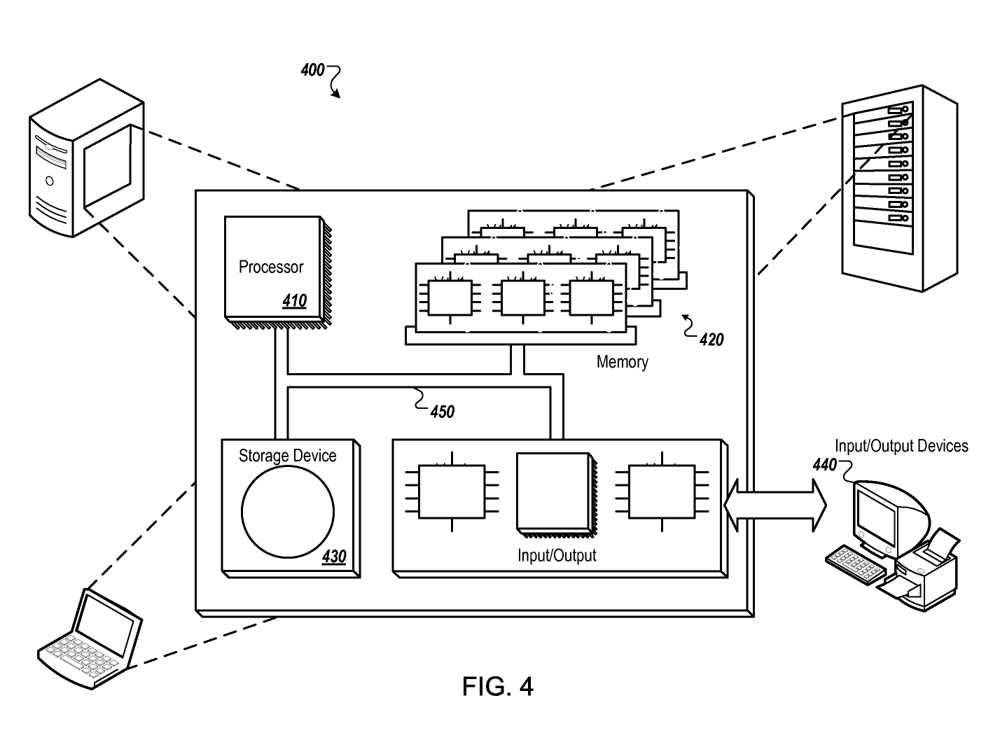

FIG. 4 is a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer-implemented method for associating a message with an item, the method comprising:
detecting a characteristic of a first item located at a first node level of a hierarchy of items;
associating a first message with the first item based on the characteristic, the first message preconfigured for presentation to a user regarding the characteristic; and
registering the first message, based on the association with the first item, to be presented at a second node level in the hierarchy in a user interface, the first node level descending from the second node level in the hierarchy.

2. The computer-implemented method of claim 1, wherein a definition for the first message specifies at least the first node and the characteristic, and wherein the first message is associated with the first item based on matching the first node and the characteristic with the definition.

3. The computer-implemented method of claim 2, wherein the definition further includes hierarchy information identifying at least one of a node level directly above the first node level in the hierarchy and a node level directly below the first node level in the hierarchy.

4. The computer-implemented method of claim 1, further comprising:
presenting the first message at the first node level of the hierarchy in the user interface, the first message indicating to the user that the first item has the characteristic.

5. The computer-implemented method of claim 4, further comprising:
receiving a first user input indicating a navigation from the first node level to the second node level;
generating a message aggregation, including aggregating the first message with any other message having been registered for presentation at the second level;
presenting the message aggregation at the second node level of the hierarchy in the user interface, the message aggregation including at least the first message and relating to a plurality of items including the first item, displayed at the second node level of the hierarchy.

6. The computer-implemented method of claim 5, wherein the message aggregation is generated based on a type of the first message, and wherein the message aggregation includes the first message and any other message of the type that has been registered for presentation at the second level.

7. The computer-implemented method of claim 5, further comprising:
receiving a second user input indicating a navigation from the second node level to the first node level; and
in response to the second user input, presenting the first node level in the user interface including at least the first item, the first message, and any other message relating to at least one of the first node level and any lower node level descending from the first node level.

8. The computer-implemented method of claim 5, further comprising:
receiving a second user input indicating a selection of a select message in the message aggregation;
in response to the second user input, generating a filtered group, including filtering the plurality of items to retain any messages relating to the select message; and
presenting the filtered group in the user interface, the filtered group associated with the select message.

9. The computer-implemented method of claim 8, wherein filtering the plurality of items includes bringing together in the filtered group items that descend through multiple node levels from a common node in the hierarchy.

10. The computer-implemented method of claim 5, further comprising:
receiving a second user input indicating a dismissal of the first message at the second node level; and
in response to the second user input, ceasing to present the first message at the second node level.

11. The computer-implemented method of claim 10, wherein after the dismissal the first message continues to be associated with the first item and is subject to presentation upon the first node level being presented.

12. The computer-implemented method of claim 1, wherein detecting the characteristic comprises applying a rule to information of the first item, the first message associated with the rule such that upon the rule being satisfied, the first message is associated with the information.

13. The computer-implemented method of claim 1, wherein the user interface is configured for use by an advertiser in managing advertisement campaigns, wherein the first item comprises a campaign component indicating that the advertiser has bid on a keyword for presenting an advertisement, wherein the first node level is a keyword level of the hierarchy.

14. The computer-implemented method of claim 13, wherein the characteristic comprises that a current status of the campaign component is that the advertisement is not being presented in response to the keyword occurring.

15. The computer-implemented method of claim 13, wherein the characteristic comprises that the campaign component is currently inactive.

16. The computer-implemented method of claim 13, wherein the characteristic comprises that the campaign component is scheduled to end within a predetermined amount of time.

17. A computer program product tangibly embodied in a computer-readable storage medium and comprising instructions that when executed by a processor perform a method for associating a message with an item, the method comprising:
detecting a characteristic of a first item located at a first node level of a hierarchy of items;
associating a first message with the first item based on the characteristic, the first message preconfigured for presentation to a user regarding the characteristic; and
registering the first message, based on the association with the first item, to be presented at a second node level in the hierarchy in a user interface, the first node level descending from the second node level in the hierarchy.

18. A computer program product tangibly embodied in a computer-readable storage medium, the computer program product including instructions that, when executed, generate on a display device a graphical user interface associating a message with an item, the graphical user interface comprising:
a node information area presenting information about any of multiple node levels in a hierarchy, the node information area including information about a first item at a first node level that is associated with a first message, the first message registered to be presented at a second node level in the hierarchy; and
a message aggregation area associated with the second node level of the hierarchy, the first node level descending from the second node level, the message aggregation area including a message aggregation comprising at least the first message and any other message relating to the hierarchy that is registered for presentation at the second level.

19. The computer program product of claim 18, wherein the graphical user interface is configured for use by an advertiser in managing advertisement campaigns, wherein the first item comprises a campaign component indicating that the advertiser has bid on a keyword for presenting an advertisement, wherein the first node level is a keyword level of the hierarchy.

20. The computer program product of claim 19, wherein the characteristic comprises at least one selected from:
a current status of the campaign component is that the advertisement is not being presented in response to the keyword occurring;
the campaign component is currently inactive; and
the campaign component is scheduled to end within a predetermined amount of time.
